(19) United States
(12) Patent Application Publication
(10) Pub. No.: US 2004/0138912 A1
(43) Pub. Date: Jul. 15, 2004

(54) Multiple listing services (MLS) data redistribution

(75) Inventor: James R. Campbell, Centennial, CO (US)

Correspondence Address: HOGAN & HARTSON LLP, IP GROUP, COLUMBIA SQUARE, 555 THIRTEENTH STREET, N.W., WASHINGTON, DC, 20004, US

(73) Assignee: Loan Recapture Services, LLC

(21) Appl. No.: 10/700,049

(22) Filed: Nov. 4, 2003

Related U.S. Application Data
(60) Provisional application No. 60/423,384, filed on Nov. 4, 2002.

(51) Int. Cl. G06F 17/60

(52) U.S. Cl. 705/1; 705/26

(57) ABSTRACT

In the present invention, the computer databases of “For Sale” listings of residential real estate properties aggregated by MLSs are retrieved electronically as frequently as daily from the MLSs and compared on a daily basis with the databases of residential property customer records uploaded by subscribers. To the extent that such comparisons identify matching residential properties from both databases, such matches are reported daily to mortgage brokers or lenders whose customer properties were matched. These reports enable the brokers or lenders to immediately contact a customer and offer that customer the best option for financing his new home.

### CROSS REFERENCE TO RELATED APPLICATIONS

The present invention claims priority from U.S. Provisional Application No. 60/423,384, filed on Nov. 4, 2002, the subject matter of which is hereby incorporated by reference in full.

### STATEMENT REGARDING SPONSORED RESEARCH OR DEVELOPMENT

Not Applicable.

### REFERENCE TO SEQUENCE LISTING

Not Applicable.

### BACKGROUND OF THE INVENTION

1. Field of the Invention

The present invention provides a system and method for searching data contained on multiple listing services and then selecting and distributing any relevant data.

2. Description of Related Art

Each day, thousands of properties in the United States are offered for sale. The real estate industry uses, as its primary search and indexing tool, various multiple listing services (MLSs) storing information on properties for sale or rent. The MLSs allow real estate brokers to list properties as well as search for properties using simple Boolean searches. For instance, real estate brokers may search for properties of certain type, cost, location and/or features.

The MLSs were formed to facilitate cooperation between real estate brokers. Two of the most important results of the formation of MLSs are (a) the compilation and dissemination of member real estate brokers' property listings into a common database for member broker usage and (b) to provide sellers with much broader market exposure. MLSs exist to offer centralized services to their broker members, to expedite the sale of a homeowner's property by generating competition among real estate agents, and to protect the integrity and use of the MLS data. An MLS's primary focus is to promote the interests of sellers, but only to the extent that such promotion is not in conflict with what is in the best interest of its broker members and their clients as a monitor and enforcer of privacy and data protection standards.

The databases compiled by the MLSs for their broker members are comprised of several types and ages of data, including: active listings of properties for sale or lease, off-market listings (including pending sale, expired and canceled listings, and withdrawn listings), sold or leased listings, and property details such as photos of the listed properties, and includes both commercial and residential properties.

While many disparate sources exist to compile some similar data, the MLS databases are an extensive and comprehensive source of detailed property and community characteristics among other information, and include approximately 82% of all properties sold annually in the U.S. The source of many of these data elements is limited to the MLS, which has a competitive advantage in the market place because it has the best currency and completeness.

Currently, there is no ability to link the MLS data to other sources of other information, such as financial institutions providing loan information, etc. However, there is a need for this type of data coordination between the mortgage and real estate industries because a seller typically does not coordinate the property sale and subsequent purchase of a second property with an existing mortgage lender or mortgage broker. Thus, most of these qualified sellers navigate the financing process with a new mortgage broker or lender, even though there would be significant advantages to the seller in using the services of their current lender, or mortgage broker. For instance, mortgage brokers or lenders want to retain their prior customers when these customers need a new loan, and satisfied customers would often gladly welcome the benefits from dealing with their current mortgage broker or lender. Possible benefits to the customers from a continued relationship potentially include but are not limited to a loan commitment letter, an expedited loan process, and preferred-customer terms and treatment from the existing mortgage broker or lender.

The mortgage brokers and lenders lose customers and force customers to spend valuable time searching for new financing because there is an information gap. Specifically, the mortgage brokers and lenders do not know when their customers sell. In fact, the mortgage broker or lender does not usually know that a sale is imminent until immediately before the new loan closes.

MLSs are further seeking to increase non-dues revenue as a membership benefit in keeping costs down and improving services. Legitimate business concerns of the participating MLSs in licensing the MLS databases include the need to stay in control of the data use, ensuring consumer privacy issues are addressed, and driving the consumer real estate information market toward their member brokers.

### BRIEF SUMMARY OF THE INVENTION

In response to these and other needs, the present invention seeks to determine and compare product line(s) and revenue opportunities available for multiple listing companies with an emphasis on business development revenue potential and product partner identification. Thus, a goal of the present invention is to consider various business development opportunities, potential product lines, and partners for MLS member organizations. In this new construct, the present invention will act as the data intermediary for participating data licensing MLSs, whereby the MLS databases may be used to produce new product lines or to enhance existing product lines. Thus, the present invention represents a new and creative approach to solving several historical challenges in the mortgage and real estate industries, while benefiting consumers, mortgage brokers, lending institutions, and realtors alike.

Aspects of the present invention are centered on collecting data from both parties and matching that data. Specifically, the present invention actively involves both the MLS segment of the real estate industry and the mortgage brokers and lenders segments of the mortgage industry. The present invention uses MLS data as an early indicator of a borrower's intent to pay off their existing mortgage loan and acquire a new loan on a new property. Mortgage brokers or lenders (hereafter referred to as “subscribers”) create a list of customers to track, based on criteria selected by the subscribers. For instance, the subscriber may provide a comprehensive tracking list of property addresses and loan origination dates.

In the present invention, the computer databases of “For Sale” listings of residential real estate properties aggregated by MLSs are retrieved electronically as frequently as daily from the MLSs and compared on a daily basis with the databases of residential property customer records uploaded by subscribers. To the extent that such comparisons identify matching residential properties from both databases, such matches are reported daily to the mortgage brokers or lenders whose customer properties were matched. These reports enable the brokers or lenders to immediately contact a customer and offer that customer the best option for financing his new home.

In embodiments of the present invention, aggregated match reports are also provided to the MLSs whose properties were matched. A service organization employing the present invention generally may pay the MLSs a fee for each matched MLS property, and the MLS may share all or a portion of this fee with the listing broker. For instance, the present invention allows a service provider to generate revenue by charging mortgage brokers and lenders fees (1) for tracking the lists of the brokers' and lenders' customer property addresses, (2) for each matched property, and (3) for each closed loan for a lender or broker resulting from a property match.

The present invention may periodically obtain updated properties listings from the MLSs and customer lists from the subscribers. The MLS properties listings may be updated frequently, such as daily. The subscriber and MLS data are compared periodically, such as daily every 24 hours, to identify matches between the respective databases. Matches of the two data sets are recorded, and a list of matches is provided to the MLS and the subscribers. The match list represents properties which are financed for a subscriber's customers and which have recently been listed for sale.

While the subscribers are the primary beneficiaries of the information flow, the present invention also provides additional benefits to all stakeholders in the process, including MLSs, customers of the mortgage brokers and lenders, realtors, and the service provider.

### BRIEF DESCRIPTION OF THE DRAWINGS

A more complete understanding of the present invention and advantages thereof may be acquired by referring to the following description taken in conjunction with the accompanying drawings, in which like reference numbers indicate like features, and wherein:

FIG. 1 (PRIOR ART) depicts the system combining several Multiple Listing Services (MLSs);

FIG. 2 depicts the steps in a method for redistributing MLS data in accordance with embodiments of the present invention; and

FIG. 3 depicts elements in a MLS redistribution system for implementing the method presented in FIG. 2 in accordance with embodiments of the present invention.

### DETAILED DESCRIPTION OF THE DRAWINGS

As described above, multiple listing services (MLSs) offer centralized services to their broker members to expedite the sale of a homeowner's property by generating competition among real estate agents. The MLS agencies are often referred to as Real Estate Data Provider Services(s) (“Data Providers” or “REDPS”). The databases compiled by the MLSs for their broker members are comprised of several types and ages of data, including active listings of properties for sale or lease, off-market listings (including pending sale, expired and canceled listings, and withdrawn listings), sold or leased listings, and property details such as photos of the listed properties.

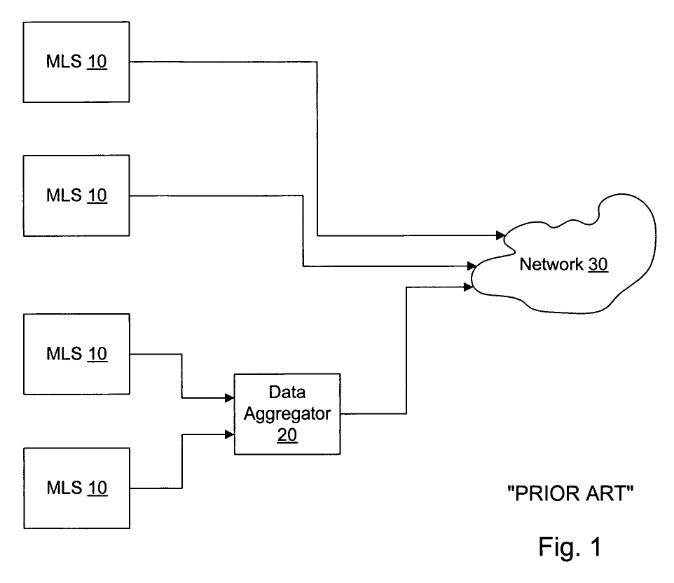

Turning now to FIG. 1 (Prior Art), each MLS 10 operates independently, collecting from and providing data to broker members. Typically, an MLS contains data from broker members in a particular area. Independent data aggregators 20 may also collect and pool data from one or more of the MLSs 10. In this way, properties listed in several different groups of real estate brokers may be accessed concurrently. Also, when searching for property listings, the MLSs 10 may be accessed through a network 30, which operates according to known conventions. Thus, an authorized user may quickly access a large number of property listings stored on multiple MLSs.

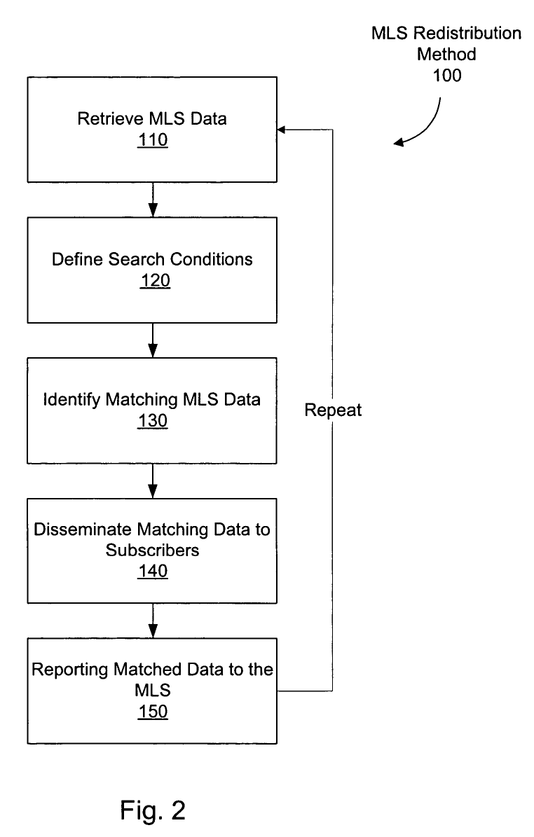

Turning now to FIG. 2, the present invention provides a Multiple Listing Service (MLS) data redistribution method 100 for identifying and distributing data contained in Multiple Listing Services (MLSs), such as the MLSs 10 described above. The MLS data redistribution method 100 generally includes the steps of (a) retrieval of data from the MLSs and similar data aggregators in step 110, (b) defining search conditions in step 120, (c) identifying MLS data meeting the specified search conditions in step 130, and (d) dissemination of the matching data to subscribers in step 140. The MLS data redistribution method 100 may further optionally include the reporting of matched data to the MLS (or data aggregator) whose data was matched, step 150.

During the retrieval of data from the MLSs and similar data aggregators (hereafter referred to as “information providers”) in step 110, the information providers supply data containing “for sale” property listings from the Information Providers' databases in electronic form. Data can be provided through manual access to a data system or retrieved automatically by an electronic automated system. Where, the data is retrieved automatically, the retrieval is accomplished in cooperation with the Information Providers. The MLS data may be automatically retrieved from the Information Providers on a frequent basis, typically daily but possibly more or less frequently.

Continuing with the MLS data redistribution method 100 in FIG. 2, the next task is to define search conditions in step 120. The data provided by the subscribers may define property characteristics of interest (e.g., property type, price, location, price, and features) and/or customers of mortgage brokers or lenders and who are of interest.

The search conditions defined in step 120 generally use data provided by subscribers that particularly identifies customers or properties of interest. For instance, subscribers may provide data on properties financed for existing customers. The subscriber may also identify geographic areas of interest. Similarly, the information provided by subscribers in step 120 may include a complete property address or legal description (if available).

In one embodiment of the present invention, the defining of search conditions in step 120 generally comprises the retrieval of data and aggregation of customer lists from subscribing mortgage brokers or mortgage lenders. In this way, the subscriber may identify potential customers of interest, whereby the subscriber wishes to be notified when one of these costumers is listing a property for sale on a MLS. Thus, the subscriber provides information identifying existing clients such as a loan identifier and loan origination date.

The criteria used by the subscriber to determine the composition of the tracking list is at the subscriber's discretion, but generally must be based on verifiable customer lists. The list may be as broad or as narrow as desired, and the subscriber may establish several criteria, and in some cases the same property may meet the specifications of more than one set of criteria.

Additional information may be provided or requested as needed to address a specific subscriber's needs, in accordance with various privacy and disclosure rules. In particular, it should be appreciated that the various data transfers in the present invention should operate in accordance with laws and regulations regarding the access, use and transfer of private information. The Gramm-Leach-Bliley Act, 12 USC §§6801-6827 (the “GLBA”) applies to financial institutions and primarily addresses the disclosure of “nonpublic personal information” (“NPPI”) to nonaffiliated third parties. NPPI includes personally identifiable financial information that is not publicly available and any list, description or other grouping of consumers that is derived using any personally identifiable financial information that is not publicly available. A financial institution essentially includes any institution that significantly engages in financial services. As a “Service Provider,” the service organization may receive, process, and return NPPI to a client financial institution. It should be appreciated that the present invention operates in accordance with these and other laws and regulations governing the use of private information, but a full understanding of these laws and regulations is generally beyond the scope of the present description.

The retrieval of subscriber data used to define search conditions in step 120 may be performed automatically. For instance, the subscriber data may be retrieved in real time upon request or at pre-established intervals, such as monthly, or more frequently at the subscriber's discretion. Subscribers preferably provide this data at least monthly or more frequently.

Returning now to FIG. 2, MLS data (from step 110) meeting the specified search conditions (defined in step 120) is identified in step 130. In particular, the MLS data retrieved in step 110 is analyzed in view of the search conditions defined in step 120. As described above, the search conditions defined in step 120 generally defines a group of properties and/or owners of interest.

In a preferred implementation of the MLS data redistribution method 100, the identification of matching information provider and subscriber data in step 130 includes the creation of a matched data set associating the matching information provider and subscriber data. In particular, this matched data set includes customer and property identifiers.

Step 130 may further include the creation of reports of all matched data for each information provider and subscriber who had matching data during the month. Such reports shall be used as the basis for paying revenue sharing or data licensing fees to information providers in exchange for access to the MLS data.

Continuing with the MLS data redistribution method 100 depicted in FIG. 2, the matching data identified in step 130 is disseminated to appropriate subscribers in step 140. In dissemination of the matching data to subscribers in step 140, the matched data transferred to subscribers typically includes information as needed to identify sellers and properties of interest, such as the complete property address or legal description, list price, listing date, listing agent's identification number, property tax identification number, and listing agent's office identification number.

Continuing with the dissemination of the matching data to subscribers in step 140, additional information may also be report as well to meet specific subscribers' needs. In general, no personal information or names of individuals is included in the data delivered to the subscribers, unless such information is received from the subscriber in their tracking list(s). Accordingly, this data may be electronically filtered to prevent such private information from being disseminated.

The dissemination of the matching data to subscribers in step 140 may be done through a number of access methods, such as (a) web services, (b) web interface reporting, (c) file download, and (d) e-mail. By using a secure web services, subscribers can access matched data at anytime. A matched data set may be identified by a subscriber's unique identifier and may include the information provided by the subscriber matched with data from the MLS such as a listing price and listing date. Alternatively, the subscriber may designate one or more Internet addresses for receiving the matched data set.

After receiving notification that a property in his customer base has been listed for sale, a subscribing mortgage broker or lender has several options. For example, the subscriber may contact the customer to offer to find the best financing solution for the customer's new property. Subscriber often may be able to work with the customer and the customer's real estate agent to assist the customer in making a credible offer for a new property by having provided a firm commitment from a lender. The subscriber may also be able to provide other services the customer needs after the customer's new loan closes. If a firm commitment has been received, the customer and the realtor will benefit from the certainty that the customer has a loan commitment for a certain amount and can afford a property within a certain price.

Thus, it can be seen that this redistribution of the MLS data is beneficial in that the MLS Data was delivered while it was still fresh enough to be of great value to the subscriber (and the customer). Furthermore, the redistributed data is delivered in a useable format and matched specifically to the needs of the subscribers.

Referring again to FIG. 2, the MLS data redistribution method 100 may also optionally include the reporting of matched data to the information provider in step 150. The information provider generally receives information identifying the set of property forwarded to each of the subscribers in step 140. Specifically, the data provided to the information providers is similar to the information provided to the subscribers but excludes information identifying the subscribers' customers. Like the subscribers, the information providers may also access to the matched data online or may receive automatic electronic delivers of the matched data.

The present invention may generate revenue by charging subscribers three types of fees:

(1) Tracking Fee—an annual per property fee for each property submitted on their Tracking Lists;

(2) Match Fee for each property match reported; and

(3) Closing Fee for each closed loan that a subscribing mortgage broker or lender is able to consummate with a matched customer.

The revenues generated by the present invention may be shared with the MLS through the payment of a percentage of each Match Fee in the month following receipt of Subscriber payment to a service provider.

In parallel with development of the MLS data redistribution method 100, the present invention includes an information technology matching, tracking, retrieval and delivery system and may be implemented with the necessary multiple data exchange protocol options, including the Mortgage Industry Standards Maintenance Organization (MISMO) and the Real Estate Transaction Set (RETS), to meet the requirements of various participating entities and/or all foreseeable future data exchange protocols.

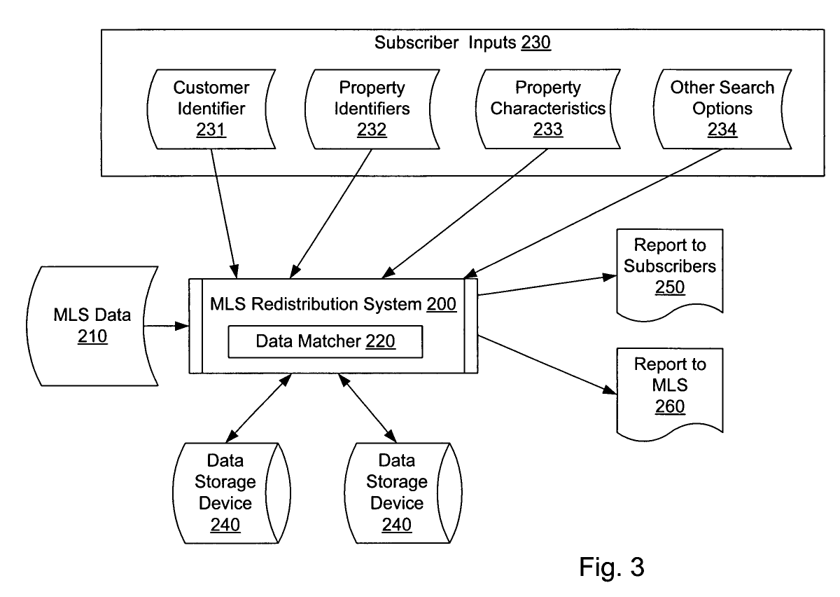

Referring now to FIG. 3 a MLS data redistribution system 200 implements the MLS data redistribution method 100. As described above, the MLS data redistribution system 200 accepts MLS data 210 which defines a set of properties offered for sale. The MLS data redistribution system 200 further receives subscriber inputs 230 that help to identify properties of interest. For instance, the subscriber inputs 230 may include specific customer identifiers 231 and property identifiers 232. The subscriber inputs 230 may further include information to abstractly define properties of interest including property characteristics 233 (e.g., location, type, size, price, etc.) or other searching options 234.

It should be appreciated that a variety of methods are used to acquire the MLS data 210 and the subscriber inputs 230, according to known techniques and technology. For instance, the MLS data 210 and the subscriber inputs 230 may be e-mailed to the MLS data redistribution system 200 using a standard e-mail exchange protocol, such as Simple Mail Transfer Protocol (SMTP). The information may also be transferred using File Transfer Protocol (FTP), the protocol used to download a file from a server using the Internet or to upload a file to a server (e.g., uploading a Web page file to a server). This information may also be transferred using Hyper Text Transfer Protocol (HTTP), a protocol used to transfer files from a Web server onto a browser in order to view a Web page that is on the Internet. Unlike FTP, where entire files are transferred from one device to another and copied into memory, HTTP only transfers the contents of a web page into a browser for viewing. While FTP is a two-way system as files are transferred back and forth between server and workstation, HTTP is a one-way system as files are transported only from the server onto the workstation's browser. STMP, FTP, and HTTP transfer data across the Internet using the Internet's TCP/IP protocols to enable data transfer. Alternatively, an application, typically written in XML or JAVA, may search a database for desired information and automatically return this information to the MLS data redistribution system 200.

The MLS data redistribution system 200 then stores the MLS data 210 and the subscriber inputs in a data storage device 240, which operates in accordance with known technology. This data may be updated periodically as needed for optimal performance. For instance, the MLS data 210 changes rapidly and may be acquired frequently, such as daily. Similarly, the more stable subscriber inputs may be refreshed weekly or monthly.

The MLS data redistribution system 200 further includes a data matching component 220 that compares the MLS data 210 and the subscriber inputs 230. The data matching component 220 then identifies MLS data entries meeting the subscriber inputs, such as sales offers related to a prespecified property or class of properties. The data matching component 220 can operate following the acquisition of new data, such as the above-described updating of the MLS data 210 and the subscriber inputs 230. The set of matched data may also be stored in the data storage device 240.

The set of matched data formed by the data matching component 220 is then outputted to the subscribers. Typically, the set of matched data is forwarded to the subscribers in the form of a subscriber report 250 in electronic format that specifies properties of interest and specifies why these properties were selected. For instance, the properties may be associated with particular customers, financial accounts, or loans. This report may then be transferred to the subscribers as described above. For instance, the subscriber may download the report 250 over the Web, a web service may automatically retrieve the report 250, a web site may report the matches, or the report may be e-mailed to the subscriber.

The MLS data redistribution system 200 sends a report to the MLS 260, listing the matched properties, but the MLS does not receive identification of the subscriber whose properties were matched.

Each subscriber receives customized subscriber reports 250, including only data specified by that subscriber. Likewise, the MLS report 260 should only include a listing of matched properties listed by that service. The system 200 also optimally electronically filters data to eliminate private information that cannot or should not be distributed, as described above. Similarly, another embodiment of the present invention encrypts the reports 250 and 260 forwarding the matched data to prevent unauthorized access to this data.

The present invention allows the MLSs to make better, more profitable use of their rich database without violating the Real Estate Settlement Procedures Act, 12 U.S.C. 2601 et seq., (“RESPA”) and/or HUD's Regulation X, 24 U.S.C. 3500, or compromising the security and integrity of their data. The present invention further allows subscribers, such as mortgage brokers and lenders, to retain valuable customer relationships and increase their volume of business.

To better understand the operation and benefits of the present invention, please consider the following scenarios.

Scenario 1: Mortgage Broker

In one example, mortgage broker “Mike Anderson” arrives at his desk and opens his mail. Among his messages is one that informs him that five of his customers have listed their homes for sale. Anderson immediately logs into his LRS (or LRS partner provider) account with his unique ID and password, and accepts the matches. The fee for the matches is immediately charged to his credit card or preferred payment method contained in his user profile. Mike immediately contacts each of these five customers and offers to find the best possible financing terms for their new home loan. To the extent these customers have not yet begun to search for financing for their new home, Anderson's offer will preclude their need to conduct such a search. Anderson has five customer renewals whose needs he otherwise would not have been able to meet because he would have been unaware of their decision to sell their old home and purchase a new home. In accepting the match, Mike agrees that in a specified number of days, say 75, his preferred payment method will be charged an additional “success” fee, which assumes that Mike will be successful in converting the match into a closed loan. A few days before the “success” fee is charged to Mike, an e-mail or account reminder is sent toMike, which gives him the ability to delay the charge if the loan has not yet closed, cancel the charge if not loan resulted from the match, or take no action and allow the charge to be posted.

Thus, it can be seen that the various embodiments of the present invention provide value and save costs for the national mortgage broker industry by supplying this timely information about the planned disposition of properties, which their customers have listed for sale. The benefits bundle for these subscribers is derived from “for sale” real estate information, which has previously been unavailable to mortgage brokers, or not available in a timely enough fashion to make it actionable, thus providing the following advantages to mortgage brokers:

1) Improve customer service,

2) Reduce customer service expenses, and

3) Increase customer retention by providing the broker with a timely alert that his customer has a need for a new mortgage.

In particular, after receiving notification that a property in his customer base has been listed for sale, a mortgage broker will have several options. For example, the mortgage broker may contact the customer to offer to find the best financing solution for the customer's new home. He may be able to work with the customer and the customer's real estate agent to assist the customer in making a credible offer for a new home by having provided a firm commitment from a lender, and he may be able to provide other services the customer needs after the customer's new loan closes. If a firm commitment has been received, the customer and the realtor will benefit from the certainty that the customer has a loan commitment for a certain amount and can afford a home within a certain price.

Overall, the present invention expands its geographical coverage of MLS data and increases its number of customers. At the same time, present invention may further increase the number of matches and the percentage that the matches represent in each mortgage broker's Tracking List in specific ZIP code areas, will increase. To better achieve these benefits, an implementation of the present invention may include tools to ensure that mortgage brokers not only make the most use of the present invention, but also that its use and success is tracked and validated to ensure their renewal and continued participation.

These are just a few of the ways in which a mortgage broker can realize significant advantages from using the present invention. Helping mortgage brokers become more efficient in finding financing for their customers' residential home loans benefits everyone in the process: realtors, home-buyers and MLSs as well as the brokers. Efficiency will mean reduced borrowing costs, faster approvals, fewer process glitches, and expedited transactions.

Scenario 2: Mortgage Lender

In another scenario, a bank employee “Jack Smith” arrives at his desk and opens his email. Among his messages is one that informs him that several bank mortgage properties are now listed for sale. He recognizes one property as belonging to a major customer of the bank who has a personal relationship with the bank's president. Smith contacts and informs the customers that they are pre-approved for new mortgage when purchasing a new property. Some of these customers accept offers for new mortgages, thus creating business for the lender. Other customers contacted by Smith decline the offer of a new loan, citing dissatisfaction with the bank's service. Smith can then forward these criticisms to appropriate persons in the bank for action. Smith may also discover that a property being offered for sale was just recently sold, thus suggesting fraudulent activity, such as property flipping.

The present invention therefore provides value and saves costs for the national mortgage industry by supplying this timely information about the planned disposition of properties that they hold as collateral. In addition to the desire to improve customer retention, the need for this information is supported by state and federal laws, and recent trends that require greater fiduciary oversight and lender vigilance in risk management.

The matched information allows the mortgage lenders/servicers to immediately verify the credit of their customers (mortgagors of the properties) and, if the credit quality meets the lender's requirements, to offer these customers financing on new homes before the customers have begun to search for other sources for financing for their new homes. These reports also provide numerous other benefits for mortgage lenders/servicers including, but not limited to, early warnings of loan payoff requests that enable the lenders/servicers to prepare payoff statements and retrieve original loan documents within statutory time limits.

In addition to mitigating run-off (i.e., current customers financing new property acquisitions through new lenders), lenders have an increasing need and desire to both oversee properties in which they hold a collateral interest and to improve customer relations. The benefits bundle to subscribers is derived from “for-sale” real estate information, which has previously been unavailable to mortgage lenders in a timely enough fashion to make it actionable. The present invention expects that the value of this information will be to help lenders:

1) improve customer service;

2) avoid penalties and/or delays in closings caused by short notice;

3) provide accurate and timely Payoff Statements;

4) locate and deliver the cancelled Original Promissory Note, and release the Deed of Trust or mortgage documentation within the time limit prescribed by law;

5) improve management efficiency in payoff departments;

6) alert foreclosure and delinquency divisions to pending property sales;

7) identify potential fraud and property “flipping;”

8) monitor potential changes in geographic distribution;

9) reduce customer service expenses;

10) maintain stable and balanced portfolios, and predict runoff;

11) increase customer retention by helping to determine whether to contact a customer for subsequent mortgage services;

12) develop new products which incorporate portability, transfer, and tranching provisions;

13) reduce brokerage, marketing, and origination costs;

14) reduce processing costs;

15) reduce loan replacement costs; and

16) increase profits through increased efficiency.

While the above-described sales, marketing and run-off opportunities are of the most obvious value to lenders, above items 2, 3, and 4 have become increasingly important to lenders, particularly in California and other states where there are significant penalties for failure to promptly re-convey property interests.

After receiving notification that a property in its portfolio has been listed for sale, lenders will have several options. As an example, the lender may contact the customer and begin the payoff notification process. The lender may choose to offer the customer a pre-approved offer to purchase a new home, using the customer's current data, loan history, and credit report as the basis for the loan decision. If the customer rejects the lender's initiative because of poor service and experience with the lender, that information can be compiled and will provide valuable feedback to the lender in its continuous customer service improvement process. A customer who accepts a pre-approved or expedited loan offer may be issued a pre-approval letter, which will benefit the customer and the realtor as the customer seeks a new home with financing already in place.

### CONCLUSION

The foregoing description of the preferred embodiments of the invention has been presented for the purposes of illustration and description. It is not intended to be exhaustive or to limit the invention to the precise form disclosed. Many modifications and variations are possible in light of the above teaching. It is intended that the scope of the invention be limited not by this detailed description, but rather by the claims appended hereto. The above specification, examples and data provide a complete description of the manufacture and use of the composition of the invention. Since many embodiments of the invention can be made without departing from the spirit and scope of the invention, the invention resides in the claims hereinafter appended.

1. A multiple listing service (MLS) data redistribution system comprising
(a) means for retrieving MLS data;
(b) means for retrieving selection data from a subscriber;
(c) means for processing and matching the MLS data with the subscriber selection data; and
(d) means for distributing the matched MLS data and the subscriber selection data to the subscriber.

2. The MLS data redistribution system of claim 1 further comprising (e) a means for reporting the matched MLS data and the subscriber selection data to a provider of the MLS data.

3. The MLS data redistribution system of claim 1, wherein the subscriber selection data comprises a customer list.

4. The MLS data redistribution system of claim 1, wherein the subscriber selection data comprises a property identification list.

5. The MLS data redistribution system of claim 1, wherein the means for distributing the matched MLS data and the subscriber selection data to the subscriber comprises means for downloading matched data over the Web; means for automatically retrieving the matched data using a web service; means for automatically accessing the matched data through a web site; and means for e-mailing the matched data.

6. The MLS data redistribution system of claim 1 further comprising a data storage means for receiving and storing data from said means for retrieving MLS data; said means for retrieving selection data from a subscriber; said means for processing and matching the MLS data with the subscriber selection data.

7. The MLS data redistribution system of claim 1, wherein the means for distributing the matched MLS data and the subscriber selection data to the subscriber comprises means for electronically filtering confidential customer data.

8. The MLS data redistribution system of claim 1, wherein the means for distributing the matched MLS data and the subscriber selection data to the subscriber comprises means for encrypting the matched data.

9. The MLS data redistribution system of claim 1, wherein the subscriber is a mortgage lender or a mortgage broker.

10. A program storage medium readable by a machine, tangibly embodying a program of instructions executable by a machine to perform method steps comprising:
(a) retrieving multiple listing service (MLS) data;
(b) obtaining selection data from a subscriber;
(c) forming a matched data set that represents MLS data that matched the selection data; and
(d) distributing the matched data set to the subscriber.

11. The program storage medium of claim 10, wherein the method steps performed by the program of instructions executable by a machine further comprises (e) reporting the matched data set to a provider of the MLS data.

12. The program storage medium of claim 10, wherein the subscriber selection data comprises a customer list.

13. The program storage medium of claim 10, wherein the subscriber selection data comprises a property identification list.

14. The program storage medium of claim 10, wherein the method step of distributing the matched data set to the subscriber, is performed using a process selected from a group consisting of:
downloading matched data over the Web;
automatically retrieving the matched data using a web service;
automatically accessing the matched data through a web site; and
e-mailing the matched data.

15. The program storage medium of claim 10, wherein the method steps performed by the program of instructions executable by a machine further comprises storing the MLS data, the selection data; and the matched data.

16. The program storage medium of claim 10, wherein the method steps performed by the program of instructions executable by a machine further comprises electronically filtering confidential customer data before performing the step of distributing the matched data set to the subscriber.

17. The program storage medium of claim 10, wherein the method steps performed by the program of instructions executable by a machine further comprises encrypting the matched data before performing the step of distributing the matched data set to the subscriber.

18. The program storage medium of claim 10, wherein the subscriber is a mortgage lender or a mortgage broker.

19. A MLS data redistribution method for correlating data on a multiple listing service (MLS) with a subscriber's customer list, the method comprising the steps of:
(a) retrieving the MLS data in an electronic format;
(b) obtaining the subscriber's customer list in an electronic format;
(c) electronically processing the MLS data the subscriber's customer list using Boolean Logic to determining matches; and
(d) electronically distributing matches to the subscriber.

20. A MLS data redistribution method of claim 19 further comprising the step of periodically repeating the retrieving, obtaining, processing, and distributing steps.
